(19) United States
(12) Patent Application Publication
(10) Pub. No.: US 2018/0059319 A1
(43) Pub. Date: Mar. 1, 2018

(54) BALLOON LIGHT STICK

(71) Applicant: Christopher Pilar Carlyle, Joliet, IL (US)

(72) Inventor: Christopher Pilar Carlyle, Joliet, IL (US)

(21) Appl. No.: 15/252,980

(22) Filed: Aug. 31, 2016

(51) Int. Cl. F21V 8/00; F21V 23/04; F21V 23/02; F21S 6/00; F21V 23/00; F21V 33/00; A63H 27/10

(52) U.S. Cl. CPC G02B 6/0096; F21V 23/04; F21V 23/02; F21Y 2115/10; F21V 23/001; F21V 33/00; A63H 27/10; F21S 6/006

(57) ABSTRACT

A lighting device is provided. The lighting device may include a base operable to support the lighting device in an upright position. A translucent rod includes an elongated body having a bottom end and a top end. The bottom end is attached to the base. A light emitting bulb is positioned to emit light into the bottom end of the translucent rod. A power supply may provide power to the light emitting bulb. A balloon may be secured to the top end of the rod.

### BACKGROUND OF THE INVENTION

The present invention relates to balloons and, more particularly, to a balloon light stick that lights up a balloon.

A balloon is a flexible bag that can be inflated with a gas, such as helium, hydrogen, nitrous oxide, oxygen or air. Modern day balloons are made from materials such as rubber, latex, polychloroprene, or a nylon fabric, and can come in many colors. Some balloons are used for decorative purposes, while others are used for practical purposes. Party balloons are mostly made of a natural latex tapped from rubber trees, and can be filled with air, helium, water, or any other suitable liquid or gas. The rubber's elasticity makes the volume adjustable. As shown in the photo to the right, they can come in different colors like the rainbow such as red, orange, yellow, green, blue, purple, etc. Currently, party balloons are not illuminated and therefore cannot be seen in dark settings.

As can be seen, there is a need for a device that lights up a balloon so the balloon may be seen in dark settings.

### SUMMARY OF THE INVENTION

In one aspect of the present invention, a lighting device comprises: a base operable to support the lighting device in an upright position; a translucent rod comprising an elongated body having a bottom end and a top end, wherein the bottom end is attached to the base; a light emitting bulb positioned to emit light into the bottom end of the translucent rod; a power supply operably connected to the light emitting bulb; and a clip secured to the top end of the translucent rod and operable to attach to a balloon.

In another aspect of the present invention, a lighting device comprises: a base operable to support the lighting device in an upright position; a translucent rod comprising an elongated body having a bottom end and a top end, wherein the bottom end is attached to the base; a light emitting bulb positioned to emit light into the bottom end of the translucent rod; a power supply operably connected to the light emitting bulb; and a balloon secured to the top end of the translucent rod.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a section detail view of an embodiment of the present invention; and

FIG. 3 is a perspective view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

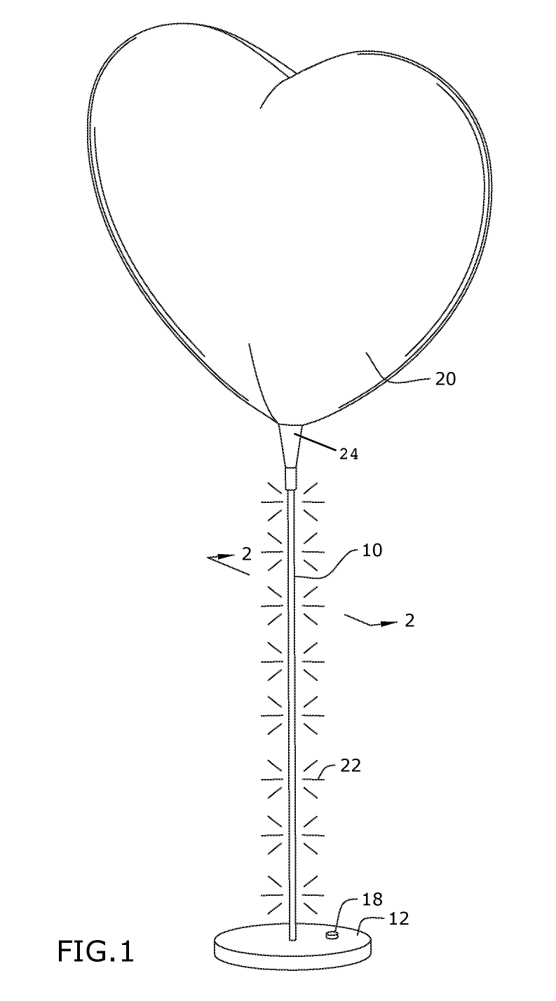

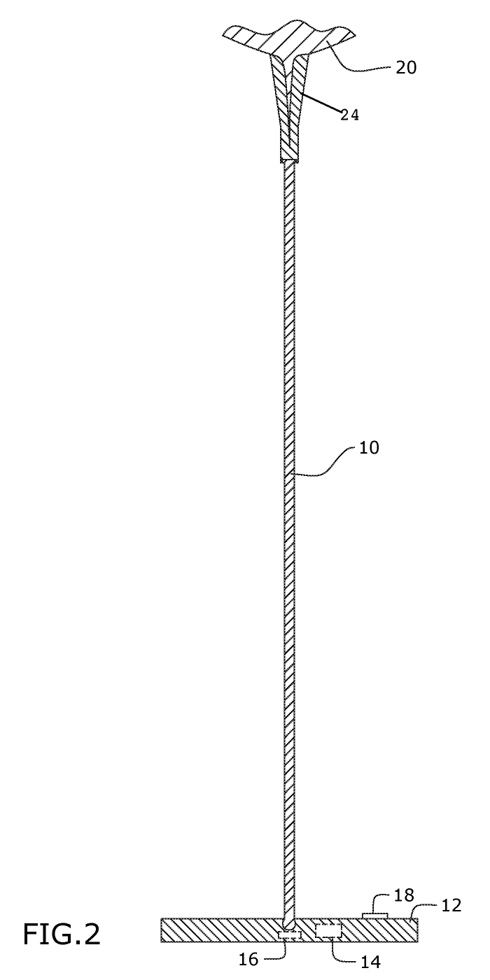

Referring to FIGS. 1 and 2, the present invention includes a lighting device. The lighting device may include a base 12 operable to support the lighting device in an upright position. A translucent rod 10 includes an elongated body having a bottom end and a top end. The bottom end is attached to the base 12. A light emitting bulb 16 is positioned to emit light into the bottom end of the translucent rod 10. A power supply 14 may provide power to the light emitting bulb 16. A balloon 20 may be secured to the top end of the rod 10.

The base 12 of the present invention maybe disc shape, square shape, triangular shape and the like. The base 12 may include a flat bottom surface. The base 12 may include decorations, such as printing or rhinestone. The light emitting bulb 16 may be embedded within the base 12. In certain embodiments, a slot may be formed in the base 12. The bottom end of the translucent rod 10 fits within the slot and thereby attaches to the base 12. The light emitting bulb 16 may be disposed below the slot.

The light emitting bulb 16 emits a light 22 into the translucent rod 10 when powered. The light 22 travels through the rod 10 and lights up the balloon 20. In certain embodiments, the light emitting bulb 16 may be a light emitting diode or other type of light bulb.

In certain embodiments, the power supply 14 is a battery. However, the present invention may utilize an electrical cord and plug that may plug into an outlet. A power button 18 may be disposed at a surface of the base 12 and is operable to close and open a circuit of the power supply 14, thereby turning on and off the light emitting bulb 16.

The rod 10 may be made of a transparent thermoplastic, such as poly(methyl methacrylate) (PMMA). The rod 10 may be in the form of a tube with a hollow core so that the light 22 prominently travels through the rod 10. The rod 10 may include a plurality of air bubbles formed in the plastic that lights up very bright. In certain embodiments, the rod 10 may be about 10 inches up to about 18 inches, such as about 15 inches.

The balloon 20 may be secured to the top end of the rod 10. In certain embodiments, a clip 24 is secured to the top end of the rod. The clip 24 may releasably retain a balloon 20. Therefore, when the balloon 20 deflates, the balloon 20 may be removed and a new balloon 20 may replace the old balloon 20.

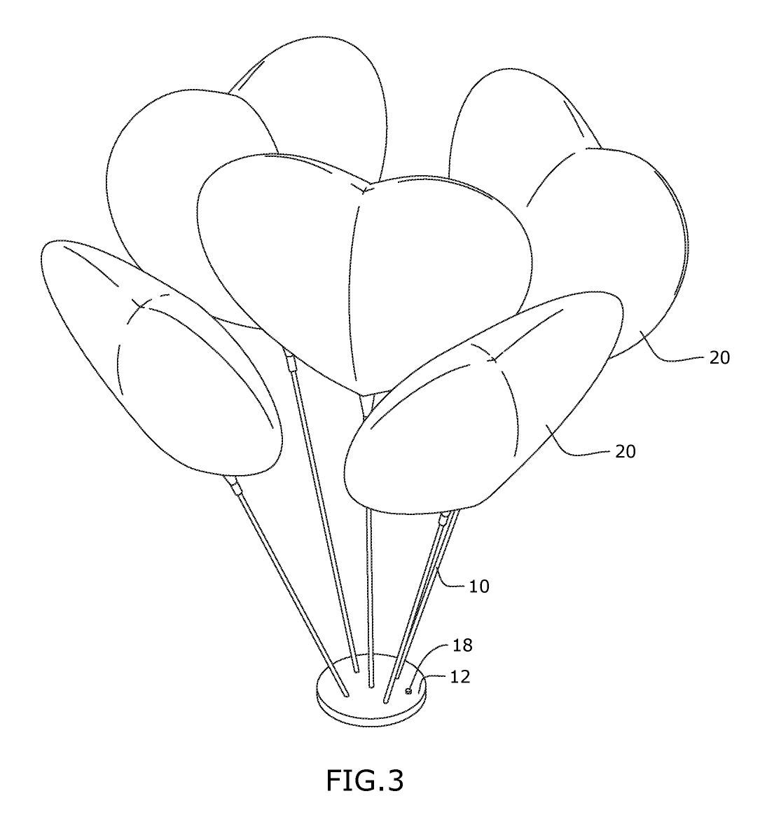

As illustrated in FIG. 3, the present invention may include a plurality of translucent rods 10 attached to the base 12. A light emitting bulb 16 may be embedded within the base 12 below each of the translucent rods 10. In such embodiments, balloons 20 may be secured to each of the rods 10. Therefore, the base 12 may light up a plurality of balloons 20.

It should be understood, of course, that the foregoing relates to exemplary embodiments of the invention and that modifications may be made without departing from the spirit and scope of the invention as set forth in the following claims.

What is claimed is:

1. A lighting device comprising:
a base operable to support the lighting device in an upright position;
a translucent rod comprising an elongated body having a bottom end and a top end, wherein the bottom end is attached to the base;
a light emitting bulb positioned to emit light into the bottom end of the translucent rod;
a power supply operably connected to the light emitting bulb; and
a clip secured to the top end of the translucent rod and operable to attach to a balloon.

2. The lighting device of claim 1, wherein the light emitting bulb is disposed within the base adjacent to the bottom end of the translucent rod.

3. The lighting device of claim 1, wherein the light emitting bulb is a light emitting diode.

4. The lighting device of claim 1, further comprising a power button disposed at a surface of the base and operable to close and open a circuit of the power supply.

5. A lighting device comprising:
a base operable to support the lighting device in an upright position;
a translucent rod comprising an elongated body having a bottom end and a top end, wherein the bottom end is attached to the base;
a light emitting bulb positioned to emit light into the bottom end of the translucent rod;
a power supply operably connected to the light emitting bulb; and
a balloon secured to the top end of the translucent rod.

6. The lighting device of claim 5, wherein the light emitting bulb is disposed within the base adjacent to the bottom end of the translucent rod.

7. The lighting device of claim 5, wherein the light emitting bulb is a light emitting diode.

8. The lighting device of claim 5, further comprising a power button disposed at a surface of the base and operable to close and open a circuit of the power supply.
